(19) United States
(12) Patent Application Publication
(10) Pub. No.: US 2016/0042857 A1
(43) Pub. Date: Feb. 11, 2016

(54) CHIP ELECTRONIC COMPONENT AND BOARD HAVING THE SAME

(71) Applicant: SAMSUNG ELECTRO-MECHANICS CO., LTD., Suwon-Si (KR)

(72) Inventors: Byoung Jin CHUN, Suwon-Si (KR); Woo Kyung SUNG, Suwon-Si (KR); Hyun Hee GU, Suwon-Si (KR); Young Sook LEE, Suwon-Si (KR); Hye Jin JEONG, Suwon-Si (KR); Jae Hwan HAN, Suwon-Si (KR)

(21) Appl. No.: 14/657,845

(22) Filed: Mar. 13, 2015

(30) Foreign Application Priority Data
Aug. 11, 2014 (KR) 10-2014-0103789

(51) Int. Cl. H01F 27/28; H01F 1/20; H01F 27/255

(52) U.S. Cl. CPC H01F 27/2804; H01F 27/255; H01F 1/20; H01F 2027/2809

(57) ABSTRACT

There are provided a chip electronic component including: a magnetic body including an insulating substrate and a conductive coil pattern which is disposed on at least one surface of the insulating substrate; and external electrodes disposed on both end portions of the magnetic body to be connected to end portions of the conductive coil pattern, wherein each of the external electrodes includes a first plating layer disposed on an end surface of the magnetic body to be connected to the conductive coil pattern and a conductive resin layer covering the first plating layer and extended to main surfaces of the magnetic body.

### CROSS-REFERENCE TO RELATED APPLICATION

This application claims the priority and benefit of Korean Patent Application No. 10-2014-0103789 filed on Aug. 11, 2014, with the Korean Intellectual Property Office, the disclosure of which is incorporated herein by reference.

### BACKGROUND

The present disclosure relates to a chip electronic component and a board having the same.

Inductors, chip electronic components, are representative passive elements configuring the electronic circuits of many devices, together with resistors and capacitors, to remove noise therefrom. Such an inductor is combined with a capacitor using electromagnetic characteristics to configure a resonance circuit amplifying a signal in a specific frequency band, a filter circuit, or the like.

Recently, as the miniaturization and thinning of information technology (IT) devices, such as communications devices, display devices, and the like, have been increasingly undertaken, research into a technology for miniaturizing and thinning various elements such as inductors, capacitors, and transistors, used in such IT devices has been continuously undertaken. Therefore, inductors have also been rapidly replaced by relatively small, high density chips, capable of being automatically surface-mounted, and thin film type power inductors, in which mixtures of magnetic powder and resins are formed as coil patterns on upper and lower surfaces of thin insulating substrates by plating have been developed.

Such power inductors, passive elements supplying currents having various voltages to various integrated circuits (IC) in products, are commonly disposed adjacently to power terminal outputs to serve to stably supply current to such ICs.

Meanwhile, as the miniaturization and high levels of performance of electronic apparatuses have been accelerated, there is a need to miniaturize components or devices used therein and to suppress heat generation by decreasing resistance at the same time.

In addition, there also is a need to decrease material costs in order to supply thin film type power inductors at competitive prices.

In the case of a general thin film type power inductor, external electrodes are provided to make electrical connections with a printed circuit board on which the thin film type power inductor is mounted, high conductivity thereof is required. Magnetic particles configuring a magnetic body and an epoxy resin layer may cause difficulty in forming external electrodes by sintering at a high temperature of 300° C. or higher.

Therefore, the external electrodes are formed using silver (Ag), or the like, a noble metal having excellent electric conductivity, as a filler. However, in this case, material costs may be increased.

### RELATED ART DOCUMENT

(Patent Document 1) Japanese Patent Laid-Open Publication No. 1999-204337

### SUMMARY

An aspect of the present disclosure may provide a chip electronic component and a board having the same.

According to an aspect of the present disclosure, a chip electronic component may include: a magnetic body including an insulating substrate and a conductive coil pattern formed on at least one surface of the insulating substrate; and external electrodes formed on both end portions of the magnetic body to be connected to end portions of the conductive coil pattern, wherein each of the external electrodes may include a first plating layer disposed on an end surface of the magnetic body to be connected to the conductive coil pattern and a conductive resin layer covering the first plating layer and extended to main surfaces of the magnetic body.

According to another aspect of the present disclosure, a board having a chip electronic component may include: a printed circuit board on which first and second electrode pads are formed; and the chip electronic component as described above, mounted on the printed circuit board.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view of a chip electronic component including internal coil patterns according to an exemplary embodiment of the present disclosure;

FIG. 2 is a cross-sectional view taken along line I-I′ of FIG. 1;

FIG. 3 is an enlarged schematic view of a part indicated by a dotted line of FIG. 2; and

FIG. 4 is a perspective view of a board in which the chip electronic component of FIG. 1 is mounted on a printed circuit board.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

### Chip Electron Component

Hereinafter, a chip electronic component according to an exemplary embodiment of the present disclosure will be described. Particularly, a thin film type inductor will be described, but the present disclosure is not limited thereto.

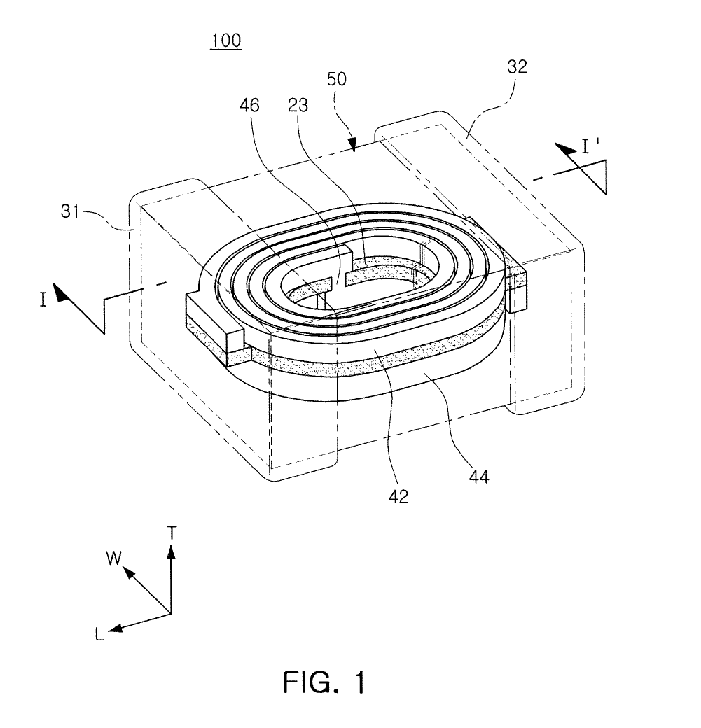

FIG. 1 is a schematic perspective view of a chip electronic component including internal coil patterns according to an exemplary embodiment of the present disclosure.

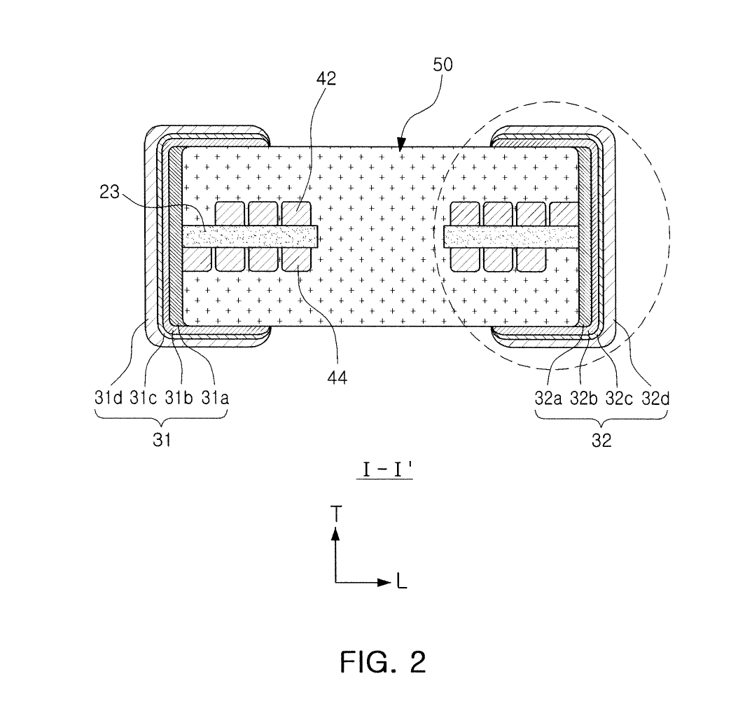

FIG. 2 is a cross-sectional view taken along line I-I′ of FIG. 1.

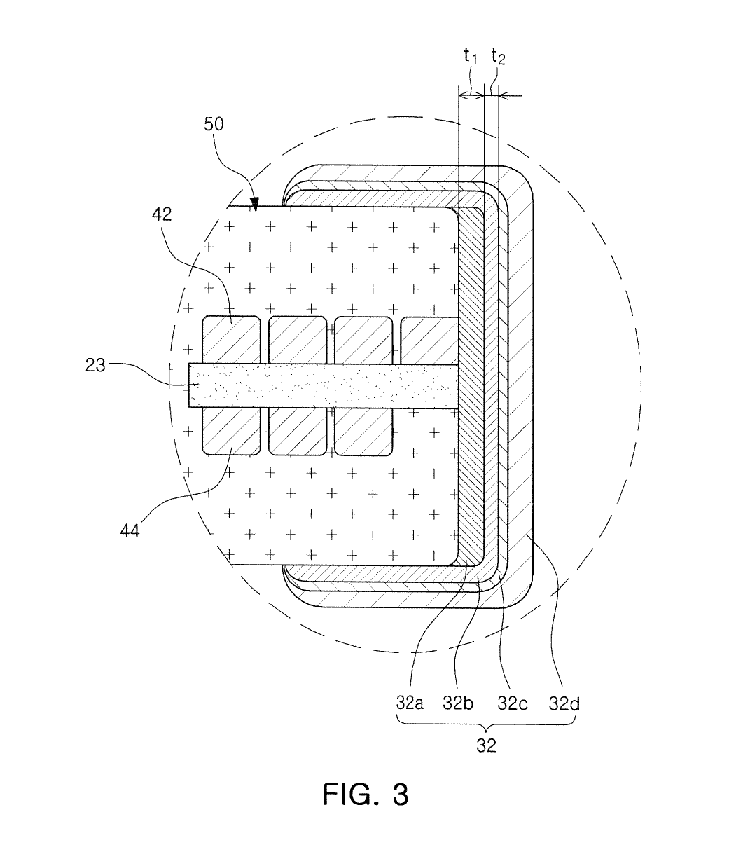

FIG. 3 is an enlarged schematic view of apart indicated by a dotted line of FIG. 2.

Referring to FIGS. 1 through 3, as an example of the chip electronic component, a thin film type power inductor 100 used in a power line of a power supply circuit is disclosed. The chip electronic component may be appropriately applied as a chip bead, a chip filter, and the like.

The thin film type power inductor 100 may include a magnetic body 50, an insulating substrate 23, conductive coil patterns 42 and 44.

The thin film type power inductor 100 may be manufactured by forming the conductive coil patterns 42 and 44 on the insulating substrate 23 and filling an external portion thereof with a magnetic material.

Meanwhile, in order to improve direct current resistance Rdc, which is one of important properties of the thin film type power inductor 100, a plating area is important. To this end, an anisotropic plating method capable of allowing the plating to grow only in an upward direction on the coil by applying a high current density may be used.

More specifically, in an insulating substrate plating process of forming the coil of the inductor, a secondary plating process of applying an insulation material such as a solder resist (SR), a dry film resist (DFR), or the like, on a specific site of the coil may be performed after a primary pattern plating process.

A pattern plating layer may be formed by the primary pattern plating process. In this process, when a photo-resist is applied on the insulating substrate and the conductive coil pattern is exposed, transferred, and developed using a photo mask, the resist may remain at a portion at which light does not reach. In this state, in the case of performing the plating and removing the remaining resist, the pattern plating layer may be formed.

The conductive coil patterns 42 and 44 maybe disposed on upper and lower portions of the insulating substrate 23 by performing the secondary plating process on the insulating substrate to allow the plating layer to grow after the primary pattern plating process.

In the case of a general thin film type inductor, high inductance L and low direct current resistance Rdc are required, and the general thin film type inductor is a component mainly used in the case in which an inductance deviation depending on a frequency needs to be small.

A material of the magnetic body 50 is not limited as long as the material may form an exterior of the thin film type inductor 100 and exhibit magnetic properties. For example, the magnetic body 50 may be formed by filling ferrite or magnetic metal particles.

As the ferrite, Mn—Zn based ferrite, Ni—Zn based ferrite, Ni—Zn—Cu based ferrite, Mn—Mg based ferrite, Ba based ferrite, Li based ferrite, or the like, may be used.

The magnetic metal particles may be formed of an alloy containing at least one selected from the group consisting of Fe, Si, Cr, Al, and Ni. For example, the magnetic metal particles may contain Fe—Si—B—Cr based amorphous metal particles, but are not limited thereto.

The magnetic metal particles may have a particle diameter of 0.1 μm to 30 μm and be contained in a form in which the magnetic metal particles are dispersed on a polymer such as an epoxy resin, polyimide, or the like.

The multilayer body 50 may have a hexahedral shape, and a direction of the hexahedron will be defined in order to clearly describe the exemplary embodiment of the present disclosure. L, W and T shown in FIG. 1 refer to a length direction, a width direction, and a thickness direction, respectively.

A material of the insulating substrate 23 formed in the magnetic body 50 is not particularly limited as long as the material may be formed in a thin film shape and the conductive coil patterns 42 and 44 may be formed thereon by plating. For example, the insulating substrate 23 may be formed of a PCB substrate, a ferrite substrate, a metal based soft magnetic substrate, or the like.

A central portion of the insulating substrate 23 is penetrated to thereby form a hole, and the hole may be filled with a magnetic material such as the ferrite, the magnetic metal particles, or the like, such that a core part may be formed. The core part filled with the magnetic material may be formed, such that inductance L may be improved.

The conductive coil pattern 42 having a coil shaped pattern may be formed on one surface of the insulating substrate 23, and the conductive coil pattern 44 having a coil shaped pattern may also be formed on the other surface of the insulating substrate 23.

The conductive coil patterns 42 and 44 may include a coil pattern having a spiral shape, and the conductive coil patterns 42 and 44 formed on one surface of the insulating substrate 23 and the other surface thereof may be electrically connected to each other through a via electrode 46 formed in the insulating substrate 23.

The conductive coil patterns 42 and 44 and the via electrode 46 may contain a metal having excellent electric conductivity. For example, the conductive coil patterns 42 and 44 and the via electrode 46 may be formed of silver (Ag), palladium (Pd), aluminum (Al), nickel (Ni), titanium (Ti), gold (Au), copper (Cu), platinum (Pt), an alloy thereof, or the like.

Meanwhile, although not shown in drawings, an insulation film may be formed on surfaces of the conductive coil patterns 42 and 44.

The insulation film may be formed by a method known in the art such as a screen printing method, an exposure and development process of a photo resist (PR), a spray application method, a dipping method, or the like.

A material of the insulation film is not particular limited as long as the material may form the insulation film in a thin film shape. For example, the insulation film may contain a photo resist (PR), an epoxy based resin, or the like.

One end portion of the conductive coil pattern 42 formed on one surface of the insulating substrate 23 may be exposed to one end surface of the magnetic body 50 in the length direction, and one end portion of the conductive coil pattern 44 formed on the other surface of the insulating substrate 23 may be exposed to the other end surface of the magnetic body 50 in the length direction.

External electrodes 31 and 32 maybe formed on both end surfaces in the length direction to be connected to the conductive coil patterns 42 and 44 exposed to both end surfaces of the magnetic body 50 in the length direction.

The external electrodes 31 and 32 may be extended to both side surfaces of the magnetic body 50 in the thickness direction and/or both side surfaces thereof in the width direction.

In addition, the external electrodes 31 and 32 may be formed on a lower surface of the magnetic body 50 and extended to both end surfaces of the magnetic body 50 in the length direction.

That is, the external electrodes 31 and 32 may be variously disposed without a particular limitation.

Referring to FIGS. 2 and 3, the external electrodes 31 and 32 may include first plating layers 31a and 32a disposed on the end surfaces of the magnetic body 50 to be connected to the conductive coil patterns 42 and 44, and conductive resin layers 31b and 32b covering the first plating layer 31a and 32a and extended to main surfaces of the magnetic body 50.

The first plating layers 31a and 32a may be disposed only on the end surfaces of the magnetic body 50 and not be extended to the main surfaces of the magnetic body 50.

That is, the first plating layers 31a and 32a may be disposed only on the end surfaces of the magnetic body 50, and only the conductive resin layers 31b and 32b and second plating layers 31c, 31d, 32c, and 32d may be disposed on the main surfaces of the magnetic body 50 as described below.

A thickness t1 of the first plating layers 31a and 32a may be 1 μm or more, and an upper limit value thereof is not particularly limited, but may be preferably 20 μm or less.

According to an exemplary embodiment of the present disclosure, direct current resistance Rdc may be effectively decreased by adjusting the thickness t1 of the first plating layers 31a and 32a to be 1 μm or more.

In the case in which the thickness t1 of the first plating layers 31a and 32a less than 1 μm, direct current resistance may not be decreased.

Meanwhile, the upper limit value of the thickness t1 of the first plating layers 31a and 32a is not particularly limited, but there are problems such as increases in a plating time and a material cost, and the like, it is preferable that the thickness t1 is 20 μm or less.

The first plating layers 31a and 32a may be formed of one or more selected from the group consisting of copper and nickel, but are not necessarily limited thereto.

According to an exemplary embodiment of the present disclosure, the external electrodes 31 and 32 may include the conductive resin layers 31b and 32b covering the first plating layers 31a and 32a and extended to the main surfaces of the magnetic body 50.

Since the conductive resin layers 31b and 32b cover the first plating layers 31a and 32a and are extended to the main surfaces of the magnetic body 50, the magnetic body 50 may have a shape in which the first plating layers 31a and 32 are disposed on the end surfaces of the magnetic body in the length direction, the conductive resin layers 31b and 32b are disposed on the first plating layers, but only the conductive resin layers 31b and 32b are disposed on the main surfaces of the magnetic body 50, and the first plating layers 31a and 32a are not disposed on the main surfaces thereof.

A thickness t2 of the conductive resin layers 31b and 32b may be 20 μm or less.

Direct current resistance Rdc may be effectively decreased by adjusting the thickness t2 of the conductive resin layers 31b and 32b to be 20 μm or less.

In the case in which the thickness t2 of the conductive resin layers 31b and 32b are more than 20 μm, direct current resistance is not decreased any more, but a thickness of the external electrodes becomes thick, such that it is not likely to implement miniaturization of a product.

Meanwhile, a lower limit value of the thickness t2 of the conductive resin layers 31b and 32b is not particularly limited, and in the case in which the thickness t2 is 0 μm, the conductive resin layers 31b and 32b are not disposed on the end surfaces of the magnetic body 50 in the length direction.

Even in this case, since the first plating layers 31a and 32b are disposed on the end surfaces of the magnetic body 50 in the length direction, direct current resistance Rdc may be effectively decreased.

The conductive resin layers 31b and 32b may contain one or more selected from the group consisting of copper (Cu) and nickel (Ni) and a thermosetting resin.

The thermosetting resin may be a polymer resin such as an epoxy resin, polyimide, or the like, but is not necessarily limited thereto.

According to an exemplary embodiment of the present disclosure, even though the first plating layers 31a and 32a and the conductive resin layers 31b and 32b uses a cheap metal such as copper (Cu) or nickel (Ni) instead of using a noble metal such as silver (Ag), or the like, direct current resistance Rdc may be effective decreased due to the above-mentioned structure.

Therefore, the chip electronic component according to an exemplary embodiment of the present disclosure may have excellent economical efficiency.

According to an exemplary embodiment of the present disclosure, the second plating layers 31c, 31d, 32c, and 32d may be further disposed on the conductive resin layers.

The second plating layers 31c, 31d, 32c, and 32d are not particularly limited, but may be disposed, for example, in a sequence of nickel (Ni) layers 31c and 32c and tin (Sn) layers 31d and 32d.

Hereinafter, a process of manufacturing a chip electronic component according to an exemplary embodiment of the present disclosure will be described.

First, conductive coil patterns 42 and 44 may be formed on an insulating substrate 23.

Conductive coil patterns 42 and 44 may be formed on a thin film type insulating substrate 23 by an electroplating method, or the like. In this case, the insulating substrate 23 is not particularly limited. For example, as the insulating substrate 23, a PCB substrate, a ferrite substrate, a metal based soft magnetic substrate, or the like, may be used, and the insulating substrate may have a thickness of 40 to 100 μm.

As a method of forming the conductive coil patterns 42 and 44, for example, there is an electroplating method, but the present disclosure is not limited thereto. The conductive coil patterns 42 and 44 may contain a metal having excellent electric conductivity. For example, silver (Ag), palladium (Pd), aluminum (Al), nickel (Ni), titanium (Ti), gold (Au), copper (Cu), or platinum (Pt), an alloy thereof, or the like, may be used.

A via electrode 46 may be formed by forming a hole in a portion of the insulating substrate 23 and filling a conductive material therein, and conductive coil patterns 42 and 44 formed on one surface of the insulating substrate 23 and the other surface thereof may be electrically connected to each other through the via electrode 46.

The hole penetrating through the insulating substrate 23 may be formed in a central portion of the insulating substrate 23 by performing a drilling, laser, sand blast, or punching process, or the like.

At the time of forming the conductive coil patterns 42 and 44, an electroplated layer may be formed by plating a lead wire on a pattern plating layer formed by a printed method.

Thereafter, a magnetic body 50 may be formed by stacking magnetic layers on upper and lower portions of the insulating substrate 23 on which the conductive coil patterns 42 and 44 are formed.

The magnetic body 50 may be formed by stacking the magnetic layers on both surfaces of the insulating substrate 23 and compressing the stacked magnetic layers by a lamination method or isostatic pressing method. In this case, a core part may be formed by filling the hole with the magnetic material.

In addition, external electrodes 31 and 32 connected to the conductive coil patterns 42 and 44 exposed to end surfaces of the magnetic body 50 may be formed.

The external electrodes 31 and 32 may be formed by forming first plating layers 31a and 32a on the end surfaces of the magnetic body 50 to be connected to the conductive coil patterns 42 and 44, and applying conductive resin layers 31b and 32b to cover the first plating layer 31a and 32a and be extended to main surfaces of the magnetic body 50.

The first plating layers 31a and 32a may be formed by a plating method, and the conductive resin layers 31b and 32b may be formed of a conductive paste containing one or more selected from the group consisting of copper (Cu) and nickel (Ni).

The conductive resin layers 31b and 32b may be formed by a dipping method, or the like, as well as a printed method according to a shape of the conductive resin layers 31b and 32b.

Then, nickel (Ni) layers 31c and 32c and tin (Sn) layers 31d and 32d may be sequentially formed on the conductive resin layers 31b and 32b.

A description of features overlapped with those of the above-mentioned chip electronic component according to an exemplary embodiment of the present disclosure will be omitted.

The following Table 1 shows a direct current resistance Rdc decreasing effect depending on a thickness t1 of the first plating layers 31a and 32a and a thickness t2 of the conductive resin layers 31b and 32b.

In the following Table 1, a case in which the direct current resistance Rdc decreasing effect was excellent was represented by “∘”, a case in which the direct current resistance Rdc decreasing effect was fair was represented by “Δ” and a case in which there was no direct current resistance Rdc decreasing effect was represented “×”.

TABLE 1

| | | | Evaluation of |
|---|---|---|---|
| Thickness (t1) | | Thickness (t2) | Direct Current |
| of First | Uniformity of | of Conductive | Resistance (Rdc) |
| Plating Layer | First Plating | Resin Layer | Decreasing |
| (μm) | Layer | (μm) | Effect |
| 0 | — | 0 | x |
| | | 10 | x |
| | | 20 | x |
| 0.5 | x | 0 | x |
| | | 10 | x |
| | | 20 | x |
| 1.0 | ∘ | 0 | ∘ |
| | | 10 | ∘ |
| | | 20 | ∘ |
| | | 30 | Δ |
| | | 40 | x |
| 10 | ∘ | 0 | ∘ |
| | | 10 | ∘ |
| | | 20 | ∘ |
| | | 30 | Δ |
| | | 40 | x |
| 20 | ∘ | 0 | ∘ |
| | | 10 | ∘ |
| | | 20 | ∘ |
| | | 30 | Δ |
| | | 40 | x |

Referring to Table 1, it may be appreciated that in the case in which the thickness t1 of the first plating layers 31a and 32a was 1 μm or more, direct current resistance Rdc may be effective decreased.

On the contrary, it may be appreciated that in the case in which the thickness t1 of the first plating layers 31a and 32a was less than 1 μm, there was no direct current resistance (Rdc) decreasing effect.

Further, it may be appreciated that in the case in which the thickness t2 of the conductive resin layers 31b and 32b was 20 μm or less, direct current resistance Rdc may be effectively decreased.

Meanwhile, it may be appreciated that in the case in which the thickness t1 of the first plating layers 31a and 32a was 1 μm or more, even though the thickness t2 of the conductive resin layers 31b and 32b was 0 μm, direct current resistance Rdc may be effective decreased.

### Board Having Chip Electronic Component

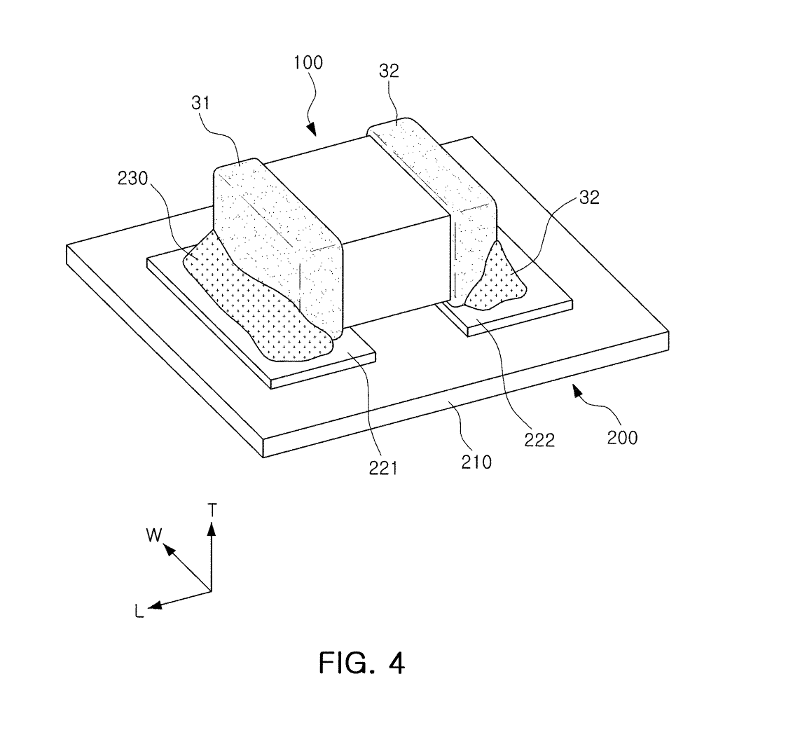

FIG. 4 is a perspective view of a board in which the chip electronic component of FIG. 1 is mounted on a printed circuit board.

Referring to FIG. 4, a board 200 having a chip electronic component 100 according to the present exemplary embodiment may include a printed circuit board 210 on which the chip electronic component 100 is horizontally mounted and first and second electrode pads 221 and 222 formed on the printed circuit board 210 to be spaced apart from each other.

In this case, the chip electronic component 100 may be electrically connected to the printed circuit board 210 by solders 230 in a state in which first and second external electrodes 31 and 32 are positioned on the first and second electrode pads 221 and 222 to contact each other, respectively.

Except for the description described above, a description of features overlapped with those of the above-mentioned chip electronic component according to an exemplary embodiment of the present disclosure will be omitted.

As set forth above, in the chip electronic component according to exemplary embodiments of the present disclosure, in spite of using a cheap base metal instead of a noble metal such as silver (Ag), direct current resistance Rdc, which is one of the main factors in performance of the inductor, may be effectively decreased.

While exemplary embodiments have been shown and described above, it will be apparent to those skilled in the art that modifications and variations could be made without departing from the scope of the present invention as defined by the appended claims.

What is claimed is:

1. A chip electronic component comprising:
a magnetic body including an insulating substrate and a conductive coil pattern which is disposed on at least one surface of the insulating substrate; and
external electrodes disposed on both end portions of the magnetic body to be connected to end portions of the conductive coil pattern,
wherein each of the external electrodes includes:
a first plating layer disposed on an end surface of the magnetic body to be connected to the conductive coil pattern; and
a conductive resin layer covering the first plating layer and extended to main surfaces of the magnetic body.

2. The chip electronic component of claim 1, wherein the first plating layer has a thickness of 1 μm or more.

3. The chip electronic component of claim 1, wherein the conductive resin layer has a thickness of 20 μm or less.

4. The chip electronic component of claim 1, wherein the conductive resin layer contains one or more selected from the group consisting of copper and nickel, and a thermosetting resin.

5. The chip electronic component of claim 1, wherein the magnetic body contains magnetic metal particles and a thermosetting resin.

6. The chip electronic component of claim 5, wherein the magnetic metal particles contain one or more selected from the group consisting of Fe, Si, Cr, Al, and Ni.

7. The chip electronic component of claim 1, wherein the first plating layer is formed of one or more selected from the group consisting of copper and nickel.

8. The chip electronic component of claim 1, further comprising a second plating layer disposed on the conductive resin layer.

9. The chip electronic component of claim 8, wherein the second plating layer includes a nickel (Ni) layer and a tin (Sn) layer which are sequentially disposed.

10. A board having a chip electronic component, the board comprising:
a printed circuit board on which first and second electrode pads are formed; and
the chip electronic component of claim 1, mounted on the printed circuit board.

11. The board of claim 10, wherein the first plating layer has a thickness of 1 μm or more.

12. The board of claim 10, wherein the conductive resin layer has a thickness of 20 μm or less.

13. The board of claim 10, wherein the conductive resin layer contains one or more selected from the group consisting of copper and nickel, and a thermosetting resin.

14. The board of claim 10, wherein the magnetic body contains magnetic metal particles and a thermosetting resin.

15. The board of claim 14, wherein the magnetic metal particles contain one or more selected from the group consisting of Fe, Si, Cr, Al, and Ni.

16. The board of claim 10, wherein the first plating layer is formed of one or more selected from the group consisting of copper and nickel.

17. The board of claim 10, further comprising a second plating layer disposed on the conductive resin layer.

18. The board of claim 17, wherein the second plating layer includes a nickel (Ni) layer and a tin (Sn) layer which are sequentially disposed.
